(19) United States
(12) Patent Application Publication
(10) Pub. No.: US 2007/0097340 A1
(43) Pub. Date: May 3, 2007

(54) Active damper with counter mass to compensate for structural vibrations of a lithographic system

(75) Inventors: Bausan Yuan, San Jose, CA (US); Ping-Wei Chang, San Jose, CA (US); Ryoichi Kawaguchi, Tokyo (JP); Kazuo Masaki, Saitama (JP); Susumu Makinouchi, Kanagawa (JP); Ting-Chien Teng, Fremont, CA (US)

Correspondence Address: AKA CHAN LLP, 900 LAFAYETTE STREET, SUITE 710, SANTA CLARA, CA, 95050, US

(73) Assignee: Nikon Corporation, Tokyo (JP)

(21) Appl. No.: 11/262,882

(22) Filed: Oct. 31, 2005

(51) Int. Cl. G03B 27/42

(52) U.S. Cl. 355/53; 355/72; 355/75

(57) ABSTRACT

Methods and apparatus for actively damping vibrations associated with a optical assembly of a photolithographic system are disclosed. According to one aspect of the present invention, an assembly that provides damping to a structure of a photolithographic apparatus that is subject to structural oscillations includes a counter mass, an active mechanism, an a controller. The active mechanism is coupled to the structure, supports the counter mass, and applies a force to the structure to counteract structural oscillations in the structure. The controller controls the force applied by the active mechanism on the structure, and utilizes information associated with movement of the structure to control the force.

### BACKGROUND OF THE INVENTION

1. Field of Invention

The present invention relates generally to damping vibrations associated with lithographic systems. More particularly, the present invention relates to an active damper with a counter mass which provides damping to a lithographic system.

2. Description of the Related Art

For precision instruments such as photolithography machines which are used in semiconductor processing, factors which affect the performance, e.g., accuracy, of the precision instrument generally must be dealt with and, insofar as possible, eliminated. When the performance of a precision instrument such a wafer scanning stage or a reticle scanning stage is adversely affected, products formed using the precision instrument may be improperly formed and, hence, function improperly.

A photolithography machine which is subjected to vibrations may cause an image to be inaccurately projected by the photolithography machine, and, as a result, be incorrectly aligned on a projection surface such as a semiconductor wafer surface. Many components of a photolithography machine typically have vibrations modes which are relatively lightly damped and difficult to suppress. By way of example, a lens mount system, which includes a lens base and sensor mount, of a photolithography apparatus generally has vibrations modes which, if not damped, may compromise the quality of an image projected onto a wafer surface. When a wafer is exposed during a scanning mode, any vibration or structural oscillation may affect the quality of an image formed on the wafer. Damping the vibrations present in a lens mount system generally enables a relatively high accuracy to be achieved for a reference position associated with the lens mount system.

Passive mass dampers are often used to damp vibrations in bodies which vibrate or have vibration modes. While the use of a passive mass damper is often effective to damp vibrations in a vibrating piece, when the vibrations change, as for example when the frequency or the magnitude of the vibrations change, a passive mass damper may no longer significantly damp the vibrations. That is, a passive mass damper is generally arranged to damp a particular range of vibrations in a body, so when the range changes, the passive mass damper may no longer be effective in damping the vibrations to which a body is subjected. As such, even when a passive mass damper is applied to a body which vibrates, e.g., a lens base or a sensor mount, the passive mass damper may not be effective in damping all vibrations to which the body is subjected. By way of example, the application of a passive mass damper to a lens mount system within a photolithographic system may not be effective to damp enough of the vibrational modes to which the lens mount system is subjected to ensure the accuracy of a photolithographic process.

Therefore, what is needed is a method and an apparatus that damps vibrations associated with a photolithography apparatus.

### SUMMARY OF THE INVENTION

The present invention relates to an active vibration damping arrangement for a photolithographic system. According to one aspect of the present invention, an assembly that provides damping to a structure, as for example a structure of a photolithographic apparatus, that is subject to structural oscillations includes a counter mass, an active mechanism, an a controller. The active mechanism is coupled to the structure, supports the counter mass, and applies a force to the structure to counteract structural oscillations in the structure. The controller controls the force applied by the active mechanism on the structure, and utilizes information associated with movement of the structure to control the force. In one embodiment, the active mechanism is a voice coil motor (VCM) arrangement. In another embodiment, the active mechanism is a piezoelectric actuator.

An active damping arrangement which actively damps vibrations in a lens system of a photolithography apparatus is effective in creating a force to damp the vibrations responsive to the frequency of the vibrations. Typically, such an active damping arrangement includes an active mechanism and a counter mass. Since the active damping arrangement is adjustable, i.e., the force generated by the active damping arrangement may be varied, a wide range of vibrational frequencies may be damped. By way of example, an active damping arrangement controlled by a notch controller may be effective in absorbing energy when the lens system is vibrating at approximately its natural frequency, as well as at other frequencies. As a result, the position of an optical central axis of a lens of the lens system may be relatively stable, and issues associated with aligning a reticle and a wafer with reference to the optical central axis may be significantly reduced.

According to another aspect of the present invention, a photolithographic apparatus includes an optical or lens assembly, a sensor arrangement, a controller arrangement, and an active damper. The lens assembly includes an optical element such as a lens, as well as a frame that supports the optical element or lens. The sensor arrangement detects movement of the lens, and generates a first signal indicative of the movement of the lens. The controller arrangement generates a control signal based on the first signal. The active damper includes an active mechanism and a counter mass, and is coupled to the lens assembly. The active mechanism is arranged to be commanded using the control signal to apply a force to the lens assembly to counteract the structural vibrations of the lens assembly.

In one embodiment, the sensor arrangement includes either an accelerometer or a velocity sensor, and detects movement of the lens system. In another embodiment, the controller arrangement is a feedforward controller arrangement. In such an embodiment, the controller arrangement may include a notch filter and an amplifier.

According to still another aspect of the present invention, a method for counteracting structural oscillations in a body of a system using an active damping arrangement that includes a controller arrangement, a sensor, and an active damper coupled to the system involves obtaining information associated with the structural oscillations using the sensor, and providing the information from the sensor to the controller arrangement. A control signal responsive to the information provided by the sensor is generated using the controller arrangement. The method also includes commanding the active mechanism using the control signal, wherein commanding the active mechanism using the control signal includes creating a force using the active mechanism. Such a force may be applied to the system to counteract the structural oscillations in the body responsive to the control signal.

In one embodiment, the sensor is mounted to the body, and the information associated with the structural oscillations is information pertaining to the movement of a central axis of the body. In such an embodiment, the force may be arranged to substantially reduce the movement of the central axis of the body.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is a block diagram representation of a photolithography apparatus in accordance with an embodiment of the present invention.

FIG. 2 is a diagrammatic representation of an active damper which includes a counter mass and a transducer with a piezoelectric arrangement in accordance with an embodiment of the present invention.

FIG. 3 is a diagrammatic representation of an active damper which includes a counter mass and a VCM in accordance with an embodiment of the present invention.

FIG. 4 is a diagrammatic cross-sectional representation of a lens assembly which includes an active damper in accordance with an embodiment of the present invention.

FIG. 5a is a block diagram representation of a control system which is suitable for utilizing information associated with vibrations of a lens assembly to control an amount of force applied by an active damper to compensate for the vibrations in accordance with an embodiment of the present invention.

FIG. 5b is a control diagram representation of a control system, i.e., control system 500 of FIG. 5a, in accordance with an embodiment of the present invention.

FIG. 5c is a control diagram representation of a control system, i.e., control system 500 of FIG. 5a, which shows the parameters of a notch filter that is suitable for use as a controller, i.e., controller 538 of FIG. 5a, in accordance with an embodiment of the present invention

FIG. 6 is a diagrammatic representation of a photolithography apparatus in accordance with an embodiment of the present invention.

FIG. 7 is a process flow diagram which illustrates the steps associated with fabricating a semiconductor device in accordance with an embodiment of the present invention.

FIG. 8 is a process flow diagram which illustrates the steps associated with processing a wafer, i.e., step 1304 of FIG. 7, in accordance with an embodiment of the present invention.

### DETAILED DESCRIPTION OF THE EMBODIMENTS

When an apparatus such a photolithography apparatus has components which vibrate, the accuracy of photolithographic processes performed using the apparatus may be compromised. For example, the stability of a lens base and a sensor mount of a lens system within a photolithographic apparatus is crucial, as an optical center of a lens is generally a reference position used to align a wafer and a reticle. In the event that the lens base and sensor mount vibrate or undergo structural oscillation, the reference position may move, and the alignment of the wafer and the reticle may need to be adjusted such that the wafer and the reticle remain aligned with the reference position. If the wafer and the reticle are not aligned with the reference position, the integrity of a photolithographic process which uses the wafer and the reticle may suffer.

The utilization an active damper to damp vibrations of a lens system, e.g., a lens base and a sensor mount, allows structural oscillation or vibrations of the lens system to be effectively damped over a range of vibrational frequencies. That is, an active damper may generate suitable amounts of force in response to various vibrational frequencies. The positional stability of a central axis of the lens system may be improved if vibrations of the lens system are reduced. An active damper, which generally includes an active mechanism and a counter mass, may be adjusted such that the force produced by the active damper may vary. More force may be provided by the active damper to counteract vibratory motion of higher frequencies, while less force may be provided to counteract vibratory motion of lower frequencies. That is, the active damper may be commanded as appropriate based upon the vibrational frequency. Hence, the active damper may damp or otherwise counteract substantially any vibrations in the lens system or assembly.

An active damper is typically small enough not to greatly affect the dynamics associated with a structure to which the active damper is coupled and arranged to damp. However, the active damper is suitable for generating a substantially direct force to compensate for structural movements or vibrations of the object to which the active damper is coupled.

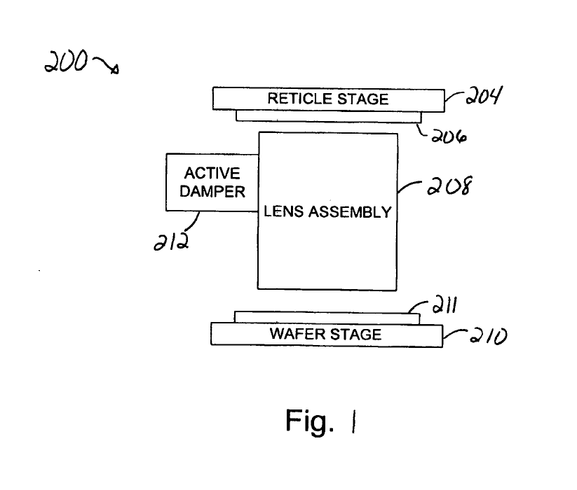

With reference to FIG. 1, the use of an active damper to provide damping to a lens assembly of a photolithographic apparatus will be described in accordance with an embodiment of the present invention. A photolithographic apparatus 200 generally includes a reticle stage 204 which supports a reticle 206 and enables reticle 206 to scan, a wafer stage 210 which supports a wafer 211 and enables wafer 211 to scan, and an optical assembly (lens assembly) 208. As optical assembly (lens assembly) 208 is generally a relatively large structure, and may include a lens base (not shown) and a sensor mount (not shown), lens assembly 208 typically has vibrations modes which are lightly damped and relatively difficult to suppress.

To suppress vibrations modes of lens assembly 208, an active damper 212 may be coupled to lens assembly 208 to provide active damping. Active damper 212 may be substantially directly mounted to lens assembly 208. Active damper 212 may be arranged, in one embodiment, to include a counter mass that is attached to an active mechanism. Such an active mechanism may be a piezoelectric actuator, e.g., an actuator that includes a piezoelectric component, or a voice coil motor (VCM) with a spring. It should be appreciated, however, that the active mechanism in active damper 212 may be substantially any suitable active mechanism which is capable of generating force.

Active damper 212 is arranged to generate a substantially direct force which acts upon lens assembly 208. Although the type of force generated by active damper 212 may vary, the force is typically an axial force. Typically, structural movement of lens assembly 208 may effectively be cancelled, i.e., vibrations in lens assembly 208 may be damped, when the force produced by the active mechanism in active damper 212 is approximately in phase with the vibrational modes associated with lens assembly. The force produced by the active mechanism may be varied as appropriate such that the force is substantially always of the correct magnitude and in the correct direction to compensate for the structural movement of lens assembly 208.

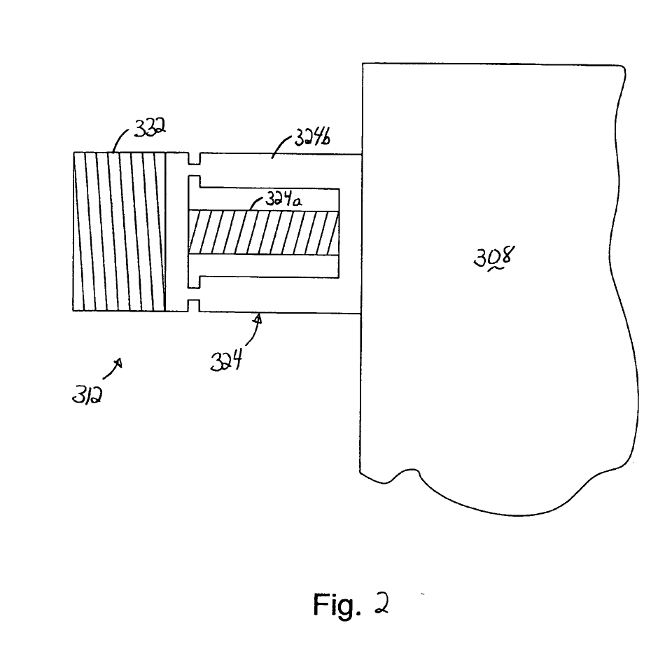

FIG. 2 is a diagrammatic representation of an active damper which includes a counter mass and a transducer with a piezoelectric arrangement in accordance with an embodiment of the present invention. An active damper 312, which is mounted on a body 308 with vibrations to be damped, includes a frame 324b and a piezoelectric component 324a which effectively form a piezoelectric arrangement 324, and a counter mass 332 that is supported by frame 324b. Piezoelectric arrangement 324 may be a piezoelectric actuator. Counter mass 332 is generally substantially directly mounted on frame 324b, while frame 324b may be substantially directly mounted to body 308. In one embodiment, body 308 is a lens structure of a lithographic system, although body 308 may be substantially any structure which has vibrations modes, e.g., vibration modes that are lightly damped and relatively difficult to suppress.

Frame 324b is arranged such that piezoelectric component 324a, e.g., a piezo stack, may move within frame 324b. As will be appreciated by those skilled in the art, a piezoelectric arrangement 324 may be a piezoelectric actuator with a piezo stack. Active damper 312 acts as a damper on body 308 by substantially producing a force that acts on body 308 using piezoelectric arrangement 324 to counteract oscillations or vibrations associated with body 308. Counter mass 332 is generally arranged to absorb reaction forces created when piezoelectric arrangement 324 acts on body 308.

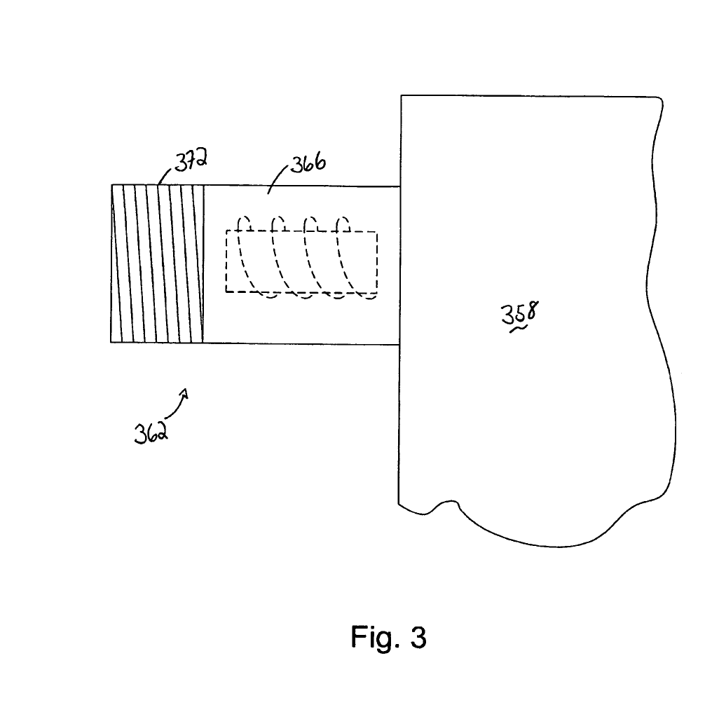

Active damper 312 is such that the amount of reaction force produced by active damper 312 may effectively be controlled by controlling the amount of voltage associated with piezoelectric arrangement 324. That is, the amount of force applied by counter mass 332 on body 308 may be controlled by piezoelectric arrangement 324. Piezoelectric arrangement 324 or, more specifically, piezoelectric component 324a in cooperation with frame 324b, is effectively the active mechanism of active damper 312. As previously mentioned, the active mechanism of an active damper may be any suitable active mechanism. By way of example, rather than including a piezoelectric arrangement, the active mechanism may instead include a VCM. FIG. 3 is a diagrammatic representation of an active damper which includes a counter mass and a VCM in accordance with an embodiment of the present invention. An active damper 362 includes a VCM 366 to which a counter mass 372 is coupled. VCM 366 may be substantially directly mounted to a body 358 which is subject to vibrations. In one embodiment, VCM 366 includes a spring and a magnet associated with VCM 366 may include a mechanical damper. Counter mass 372 is arranged to cooperate with VCM 336 to apply force as appropriate in order to reduce the vibrations associated with body 358.

The use of an active damper on a lens assembly of a photolithography apparatus reduces vibrations in the lens assembly and, hence, enables a wafer and a reticle to more effectively track a lens of the lens assembly. In other words, by actively damping vibrations in a lens assembly, the ability of a wafer and a reticle to remain aligned with the lens of the lens assembly is enhanced. For example, when the vibrations of a lens may be dampened such that an optical center of the lens is less likely to move, the alignment of a wafer and a reticle relative to the optical center is facilitated.

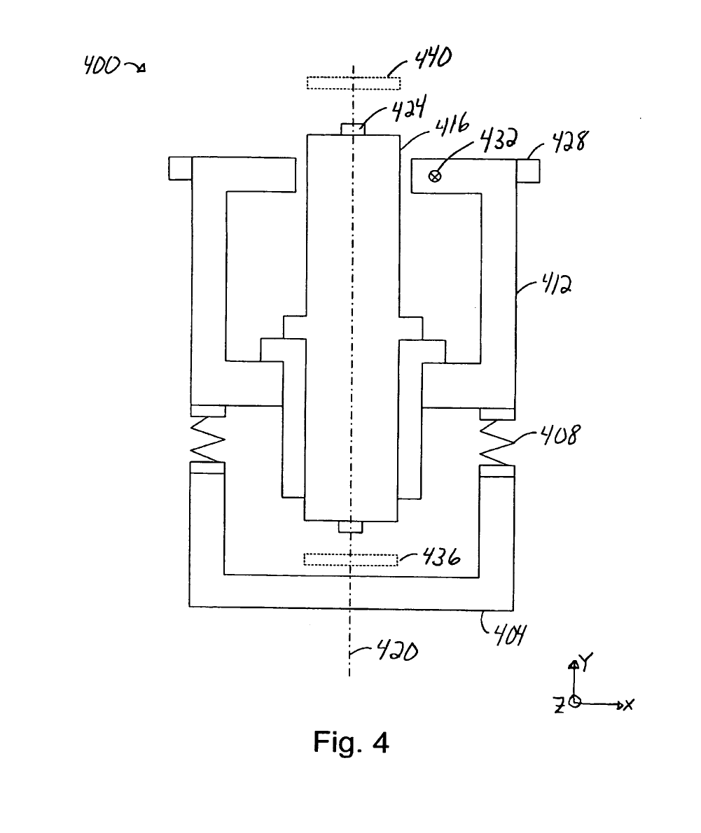

With reference to FIG. 4, an optical assembly (lens assembly) that is acted upon by an active damper will be described in accordance with an embodiment of the present invention. FIG. 4 is a diagrammatic cross-sectional representation of a lens mount assembly. A lens mount assembly 400 includes a base 404 that is arranged to support a frame 412 which supports a lens 416. Frame 412 and base 404 may be coupled by an isolation mount 408. An active damper 428 is positioned on frame 412 in a position near a load point 432 of lens assembly 400. Active damper 428 typically includes an active mechanism such as a PZT actuator or a VCM, as well as a counter mass. It should be appreciated, however, that active damper 428 may take on substantially any suitable configuration.

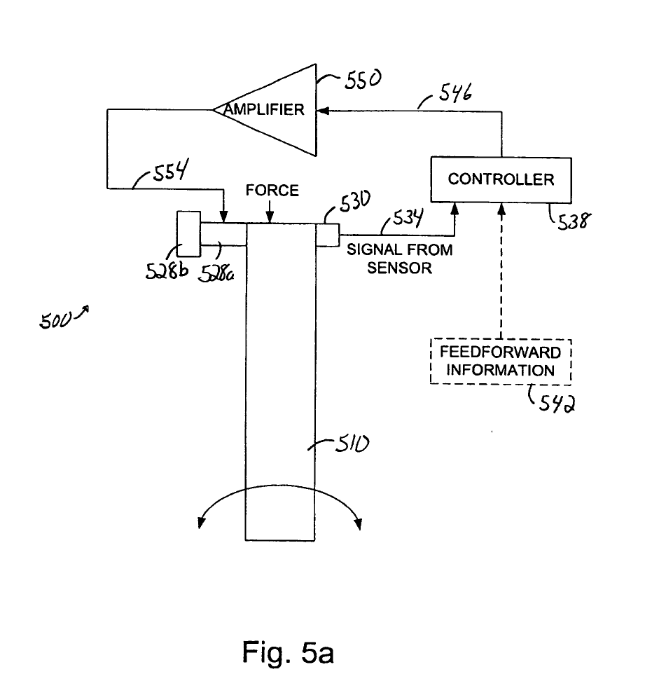

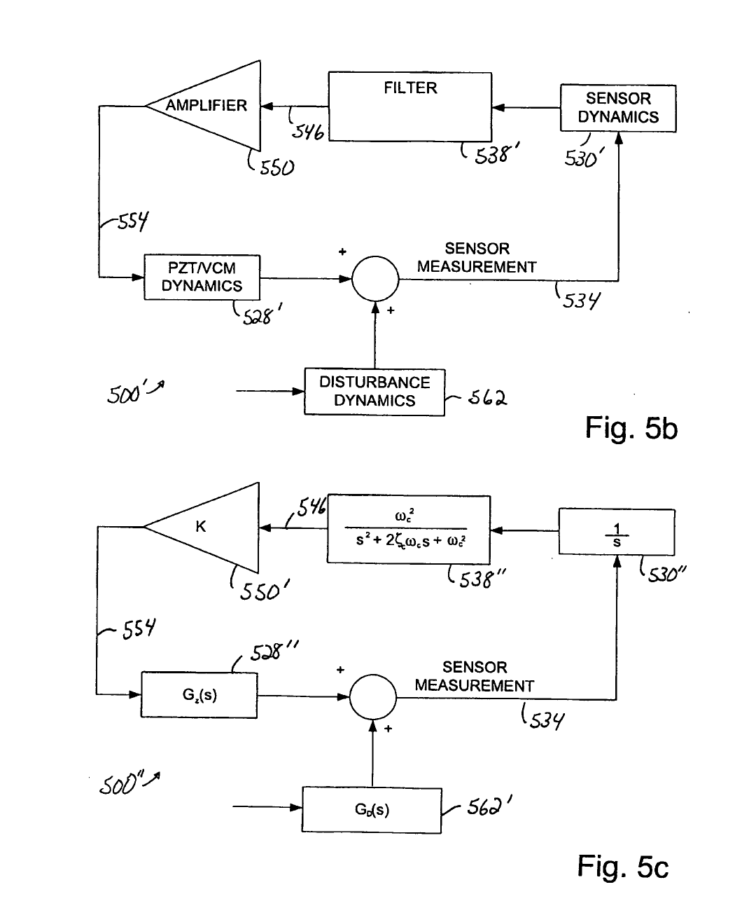

Active damper 428 uses information pertaining to the vibrational movement of lens 416 to determine an amount of damping, e.g., an amount of force, to apply to lens 416 to reduce the vibrational movement. As shown, active damper 428 damps vibrations in lens 416 by damping vibrations in frame 412 which is coupled to lens 416. A sensor 424 is mounted on lens 416 is arranged to monitor the movement of lens 416, and may be positioned along an optical center 420 of lens 416. Sensor 424 is arranged to obtain information that is then provided via circuitry or a computer system, or both, to active damper, as will be discussed below with respect to FIG. 5a. In one embodiment, sensor 424 may be an accelerometer which measures the acceleration of lens 416 when lens 416 vibrates. Sensor 424 may also be a velocity sensor which measures the velocity of lens 416.

It should be appreciated that a sensor such as sensor 424 may be mounted in a variety of different locations. By way of example, a sensor may be located at or near load point 432, or in proximity to active damper 428. In one embodiment, multiple sensors such as sensor 424 may be located at or near load point 432 and in proximity to active damper 428.

By reducing vibratory motion in lens 416, both a wafer 436 onto which an image is to be formed and a reticle 440 which provides a pattern to be formed on wafer 436 may be more accurately positioned. As both wafer 436 and reticle 440 are typically aligned using optical center 420 as a reference point. Hence, when vibrations in lens 416 are reduced using active damper 428, optical center 420 typically moves less and, as a result, the alignment of wafer 436 and reticle 440 relative to optical center 420 is facilitated. The need to adjust the positioning of wafer 436 and reticle 440 to substantially track optical center 420 is decreased, as reducing vibrations in lens 416 reduces the movement of optical center 420 and facilitates the accurate positioning of optical center 420. Further, the accuracy of images projected onto wafer 436 is improved, as the position of optical center 420 is less likely to fluctuate.

Active damper 428 generally uses information obtained or otherwise received from sensor 424 in the generation of force. By way of example, the amount of force applied to frame 412 by an active mechanism of active damper 428 may be adjusted based upon information obtained from sensor 424. Referring next to FIG. 5a, a control system which is suitable for utilizing information associated with the movement or vibrations of a lens to control an amount of force applied by an active damper to compensate for the movement or the vibration will be described in accordance with an embodiment of the present invention. A control system 500 includes an object 510 that is to be controlled. Specifically, object 510 is a vibrating body, e.g., a lens, in which vibrations or structural oscillations are to be damped. An active damper 528, which includes an active mechanism 528a and a counter mass 528b, is arranged to provide force which counteracts the vibrations of object 510.

A sensor 530, which is arranged to effectively sense motion of object 510, is coupled to object 510. As previously mentioned, sensor 530 may be an accelerometer which senses any acceleration of object 510, a velocity sensor which senses the velocity of object 510, or any other suitable sensor which effectively detects motion of object 510. Sensor 530 generates a signal 534 which is then provided to a controller 538 which is arranged to utilize signal 534, as well as feedforward information 542 in one embodiment, to create a control signal 546. Feedforward information 542 may include information pertaining to the dynamics of disturbances which affect or cause the vibration of object 510, as well as dynamics associated with sensor 530.

Controller 538 may be any suitable controller, as for example a feedforward controller, which cooperates with an amplifier 550 to generate an amplified control signal 554 that commands active damper 528 to generate a force to counteract vibrations in object 510. In one embodiment, controller 538 may include a notch filter controller. By properly adjusting the filter parameters in controller 538, control system 500 provides effective vibration suppression for object 510. Further, controller 538 is arranged such that control system 500 substantially reacts to vibrations only when necessary, as for example when vibrations are of a frequency that is at a natural frequency of object 510 or higher. In general, controller 538, in concert with other components of control system 500, essentially creates a notch effect, and enables energy at a natural frequency of object 510 to effectively be absorbed by active damper 528 to damp the vibrations of object 510. Typically, the parameters of the notch filter may be selected to provide a high degree of vibration suppression particularly for vibration modes at approximately the natural frequency associated with object 510.

Amplifier 550 is arranged to amplify control signal 546, and to provide amplified control signal 554 to active damper 528 or, more specifically, to active mechanism 528a. Active mechanism 528a then responds to amplified control signal 554, and creates a force which is applied to object 510 to counteract vibrations of object 510. In other words, amplified control signal 554 drives active mechanism 528a.

FIG. 5b is a control diagram representation of a control system, i.e., control system 500 of FIG. 5a, in accordance with an embodiment of the present invention. A control system 500′ is arranged such that dynamics 528′ of an active mechanism, e.g., active mechanism 528a of FIG. 5a, and dynamics associated with disturbances acting on an object, e.g., object 510 of FIG. 5a, are used to control the force applied by the active mechanism to the object. Typically, dynamics 528′ of the active mechanism are associated with a piezoelectric actuator or a VCM. Dynamics 528′ of the active mechanism and disturbance dynamics 562 affect sensor measurement 534, which is processed using sensor dynamics 530′.

Sensor measurement 534, after being processed using sensor dynamics 530′, is provided to a filter 538′ which, in the described embodiment, is a notch filter. Control signal 546, which is an output of filter 538′, is then provided to amplifier 550. An output of amplifier 550, which is amplified control signal 554, is then processed in accordance with dynamics 528′ of the active mechanism to create a force that acts on the object. It should be appreciated that when filter 538′ is a notch filter, amplified control signal 554 may have a profile that is indicative of a notch filter.

With reference to FIG. 5c, the parameters of a notch filter that is suitable for use as a controller, i.e., controller 538 of FIG. 5a, will be described in accordance with an embodiment of the present invention. Within a control system 500″, disturbance dynamics 562′ may be represented as a transfer function GD(s). Similarly, dynamics 528″ of an active mechanism of an active damper may be represented by a transfer function GZ(s). As will be appreciated by those skilled in the art, GD(s) and GZ(s) may vary depending upon the configuration of an object and an active damper, respectively.

Sensor dynamics 530″ may be represented, in one embodiment, as an integrator 1/s. It should be appreciated, however, that sensor dynamics 530″ may vary widely depending upon the type of sensor used, or the physical structure of the sensor that is used. A transfer function 538″ associated with a controller may be represented as

$$\frac{{ω}_{c}^{2}}{{s}^{2} + 2 {ξ}_{c} {ω}_{c} s + {ω}_{c}^{2}} ,$$

where ω_{c} is a frequency parameter and ξ_{c} is a damping parameter that are each chosen to enable control signal 546, as well as amplified control signal 554, to have the profile of a notch filter. Amplifier 550′, which has a gain K, is such that gain K is sufficient to create an amplified control signal 554 that is suitable for driving an active mechanism to suppress vibrations in an object.

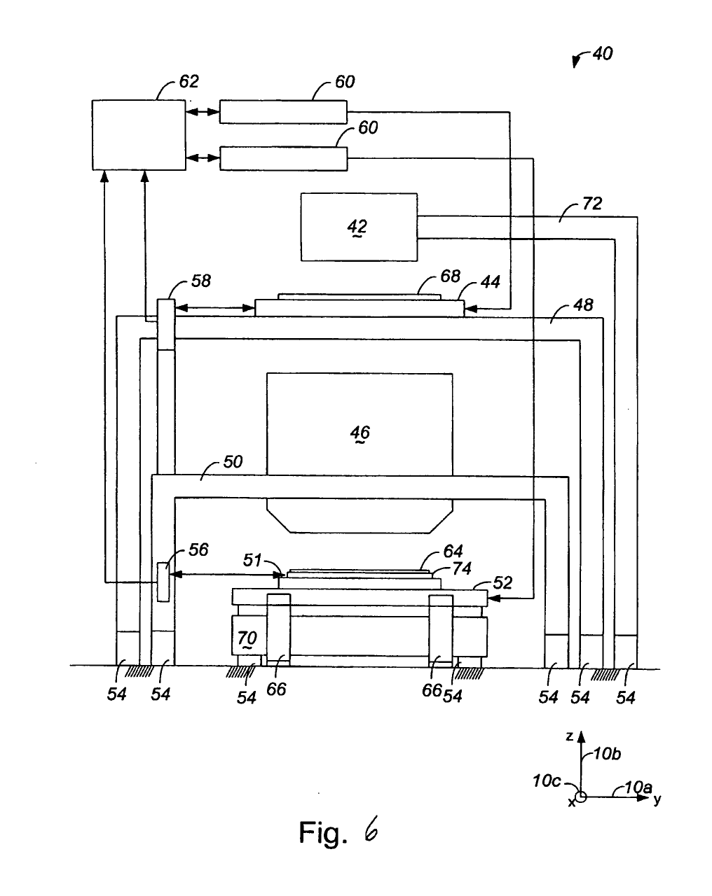

Referring next to FIG. 6, a photolithography apparatus which may utilize an active damper with a counter mass will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator. The planar motor which drives wafer positioning stage 52 generally uses an electromagnetic force generated by magnets and corresponding armature coils arranged in two dimensions. A wafer 64 is held in place on a wafer holder or chuck 74 which is coupled to wafer table 51. Wafer positioning stage 52 is arranged to move in multiple degrees of freedom, e.g., between three to six degrees of freedom, under the control of a control unit 60 and a system controller 62. In one embodiment, wafer positioning stage 52 may include a plurality of actuators which are coupled to a common magnet track. The movement of wafer positioning stage 52 allows wafer 64 to be positioned at a desired position and orientation relative to a projection optical system 46.

Wafer table 51 may be levitated in a z-direction 10b by any number of VCMs (not shown), e.g., three voice coil motors. In the described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Frame 72 may be part of a lens mount system of illumination system 42, and may be coupled to an active damper (not shown) which damps vibrations in frame 72 and, hence, illumination system 42. Illumination system 42 includes an illumination source, and is arranged to project a radiant energy, e.g., light, through a mask pattern on a reticle 68 that is supported by and scanned using a reticle stage 44 which includes a coarse stage and a fine stage. The radiant energy is focused through projection optical system 46, which is supported on a projection optics frame 50 and may be supported the ground through isolators 54. In one embodiment, projection optics frame 50 is coupled to an active damper (not shown) that is arranged to apply a variable force through a load point of projection optics frame in order to compensate for vibrational modes associated with projection optics frame 50. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optics frame 50, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer positioning stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

Further, the present invention may be utilized in an exposure apparatus that comprises two or more substrate and/or reticle stages. In such an apparatus, e.g., an apparatus with two substrate stages, one substrate stage may be used in parallel or preparatory steps while the other substrate stage is utilizes for exposing. Such a multiple stage exposure apparatus is described, for example, in Japan patent Application Disclosure No. 10-163099, as well as in Japan patent Application Disclosure No. 10-214783 and its U.S counterparts, namely U.S. Pat. No. 6,341,007, U.S. Pat. No. 6,400,441, U.S. Pat. No. 6,549,269, U.S. Pat. No. 6,590,634. Each of these Japan patent Application Disclosures and U.S. patents are incorporated herein by reference in their entireties. A multiple stage exposure apparatus is also described in Japan patent Application Disclosure No. 20000-505958 and its counterparts U.S. Pat. No. 5,969,441 and U.S. Pat. No. 6,208,407, each of which are incorporated herein by reference in their entireties.

The present invention may be utilized in an exposure apparatus that has a movable stage that retains a substrate (wafer) for exposure, as well as a stage having various sensors or measurement tools, as described in Japan patent Application Disclosure No. 11-135400, which is incorporated herein by reference in its entirety. In addition, the present invention may be utilized in an exposure apparatus that is operated in a vacuum environment such as an EB type exposure apparatus and an EUVL type exposure apparatus when suitable measures are incorporated to accommodate the vacuum environment for air (fluid) bearing arrangements.

Further, in photolithography systems, when linear motors (see U.S. Pat. No. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces, i.e., vibrational forces, which are experienced by a stage assembly or, more generally, by a photolithography machine such as photolithography apparatus 40 which includes a stage assembly.

A photolithography system according to the above-described embodiments, e.g., a photolithography apparatus which may include an active damper which damps vibrations associated with a lens mount system of the photolithography apparatus, may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

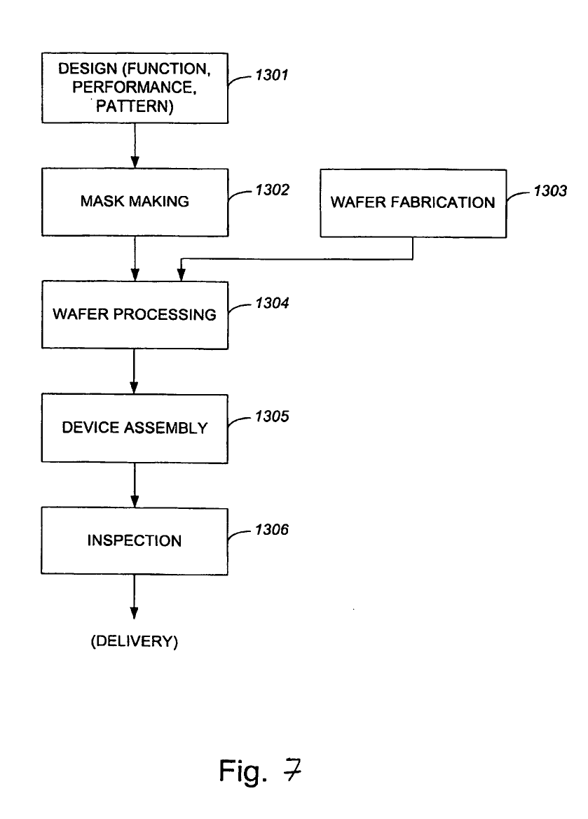

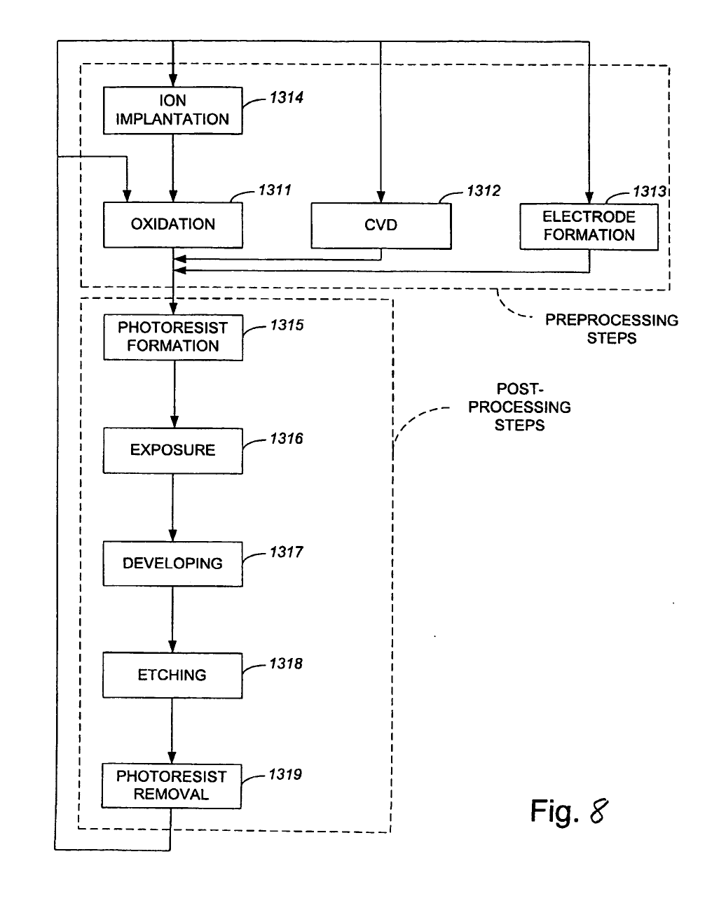

Further, semiconductor devices may be fabricated using systems described above, as will be discussed with reference to FIG. 7. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 8. In step 1305, the semiconductor device is assembled. The assembly of the semiconductor device generally includes, but is not limited to, wafer dicing processes, bonding processes, and packaging processes. Finally, the completed device is inspected in step 1306.

FIG. 7 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to damp vibrations.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, an active damper which includes an active mechanism and a damper may be used to suppress vibrations in structures other than a lens assembly associated with a photolithography apparatus. Other structures which may benefit from the vibration suppression afforded by an active damper of the present invention include, but are not limited to, a wafer stage assembly and a reticle stage assembly of a photolithography apparatus. For instance, the present invention may be useful in a loading system that loads a wafer or a reticle onto a wafer positioning stage (wafer table) or reticle stage, respectively, or an unloading system that unloads a wafer or a reticle from a wafer positioning stage (wafer table) or reticle stage, respectively. Further, the present invention may be utilized as a component of a precision machine such as a measuring device.

A sensor which is used to monitor the movement of an optical center of a lens may generally be any sensor, or any mechanism, that is able to detect vibrational movement of the lens. That is, while a sensor which monitors the movement of a lens has been described as being an accelerometer or a velocity sensor, an accelerometer and a velocity sensor are merely examples of suitable sensors. For example, a position sensor that detects the position of a lens relative to a reference position may be utilized as a sensor.

A controller associated with an active damper system has been described as being a notch filter. A notch filter is particularly suitable, in one embodiment, for effectively absorbing energy at or near the natural frequency of a vibrating object while suppressing vibrations at other frequencies when parameters of the notch filter are selected appropriately. However, a notch filter is just one example of a suitable controller for use in controlling or otherwise commanding an active damper. For example, one of a low pass filter, a high pass filter, and a band-pass filter, or a combination of these filters, may be utilized in a controller in lieu of a notch filter. Many other types of controller may be used in lieu of a notch filter. Additionally, the transfer function which represents a controller within a control system may vary widely without departing from the spirit or the scope of the present invention. Therefore, the present examples are to be considered as illustrative and not restrictive, and the invention is not to be limited to the details given herein, but may be modified within the scope of the appended claims.

What is claimed is:

1. An assembly, the assembly being arranged to provide damping to a structure, the structure being subject to vibrations, the assembly comprising:
a counter mass;
an active mechanism, the active mechanism being coupled to the structure, wherein the active mechanism is arranged to support the counter mass and to apply a force to the structure to counteract structural movement of the structure; and
a controller connected to the active mechanism, the controller being arranged to control the force applied by the active mechanism on the structure, wherein the controller utilizes information associated with movement of the structure to control the force applied by the active mechanism on the structure.

2. The assembly of claim 1 wherein the active mechanism is one of a voice coil motor (VCM) arrangement and a piezoelectric actuator.

3. The assembly of claim 1 wherein the controller is a filter controller.

4. The assembly of claim 1 wherein the structure is an optical assembly of a photolithographic apparatus.

5. The assembly of claim 4 wherein the optical assembly includes at least one optical element and a frame that supports the at least one optical element, and wherein the assembly is coupled to the frame.

6. The assembly of claim 1 wherein the structure is a stage.

7. An exposure apparatus including the assembly of claim 1.

8. A device manufactured with the exposure apparatus of claim 7.

9. A wafer on which an image has been formed by the exposure apparatus of claim 7.

10. A photolithographic apparatus comprising:
an optical assembly, the optical assembly including at least one optical element and a frame, wherein the frame is arranged to support the at least one optical element;
a sensor arrangement, the sensor arrangement being arranged to detect movement of the at least one optical element, the sensor arrangement further being arranged to generate a first signal indicative of the movement of the at least one optical element;
a controller arrangement connected to the sensor arrangement, the controller arrangement being arranged to generate a control signal based on the first signal; and
an active damper, the active damper including an active mechanism and a counter mass, the active damper being coupled to the optical assembly, wherein the active mechanism is connected to the controller arrangement and arranged to be commanded to apply a force to the optical assembly using the control signal, the force being arranged to counteract structural movement of the optical assembly.

11. The photolithographic apparatus of claim 10 wherein the active mechanism is one 20 of a voice coil motor and a piezoelectric actuator, and the counter mass is coupled to the active mechanism.

12. The photolithographic apparatus of claim 10 wherein the active mechanism is coupled to the frame.

13. The photolithographic apparatus of claim 10 wherein the sensor arrangement includes one of an accelerometer and a velocity sensor, and wherein the sensor arrangement is arranged to detect movement of an optical central axis of the at least one optical element.

14. The photolithographic apparatus of claim 10 wherein the controller arrangement is a feedforward controller arrangement.

15. The photolithographic apparatus of claim 14 wherein the controller arrangement includes a filter and an amplifier.

16. A device manufactured with the photolithographic apparatus of claim 10.

17. A wafer on which an image has been formed by the exposure apparatus of claim 16.

18. A method for counteracting structural oscillations in a body of a system using an active damping arrangement, the active damping arrangement including a controller arrangement, a sensor, and an active damper coupled to the system, the active damper including an active mechanism and a counter mass, the method comprising:
obtaining information associated with the structural oscillations using the sensor;
providing the information from the sensor to the controller arrangement;
generating a control signal using the controller arrangement responsive to the information provided by the sensor; and
commanding the active mechanism using the control signal, wherein commanding the active mechanism using the control signal includes creating a force using the active mechanism, the force being arranged to be applied to the system to counteract the structural oscillations in the body responsive to the control signal.

19. The method of claim 18 wherein the sensor is mounted to the body, and the information associated with the structural oscillations is information pertaining to the movement of a central axis of the body.

20. The method of claim 19 wherein the force is arranged to substantially reduce the movement of the central axis of the body.

21. The method of claim 18 wherein the body is at least one optical element and the system further including a frame that supports the at least one optical element.

22. The method of claim 21 wherein the active damping arrangement is mounted on the frame and the force is arranged to be applied to the frame.

23. The method of claim 18 wherein the controller includes a filter and an amplifier, and wherein generating the control signal using the controller includes providing the information as an input to the filter, creating an output from the filter, and amplifying the output from the filter using the amplifier to generate the control signal.

24. The method of claim 18 wherein the active mechanism is one of a voice coil motor arrangement and a piezoelectric actuator.

25. The method of claim 18 wherein the controller arrangement includes a feedforward controller, the method further including:
providing information pertaining to disturbances associated with the system to the controller arrangement; and
providing information pertaining to dynamics associated with the system to the controller arrangement, wherein generating the control signal using the controller arrangement responsive to the information provided by the sensor includes generating the control signal using the controller arrangement responsive to the information pertaining to disturbances and the information pertaining to dynamics.

26. The method of claim 18 wherein the sensor is an accelerometer, and the information provided by the sensor is information associated with acceleration of the body.

27. The method of claim 18 wherein the sensor is a velocity sensor, and the information provided by the sensor is information associated with velocity of the body.

28. A method for operating a photolithography apparatus comprising the method for counteracting structural vibrations of claim 18, the system being an optical assembly of the photolithography apparatus.

29. A method for making an object including at least a photolithography process, wherein the photolithography process utilizes the method for operating a photolithography apparatus of claim 28.

30. A method for making a wafer utilizing the method of operating a photolithography apparatus of claim 28.
